(19) United States
(12) Patent Application Publication
(10) Pub. No.: US 2007/0004244 A1
(43) Pub. Date: Jan. 4, 2007

(54) PGA socket connector with cover

(75) Inventor: Hao-Yun Ma, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/479,809

(22) Filed: Jun. 29, 2006

(30) Foreign Application Priority Data
Jul. 1, 2005 (TW) 94122330

(51) Int. Cl. H01R 12/00

(52) U.S. Cl. 439/71

(57) ABSTRACT

An electrical connector (10) includes a socket body (20) and a plurality of contacts (30). The socket body defines a mating surface (202) and a number of passageways (204) extending from the mating surface. Each contact includes a base portion (300), a pair of arm sections (302) extending from two opposite lateral sides of the base portion, and a contacting end (305) forming at a free end of the arm section. The contacting end extends upwardly and outwardly with a part extending out of the mating surface. A cover (40), having a number of through-holes (402) corresponding to the passageways, is mounted on the socket body.

### BACKGROUND OF THE INVENTION

1. Field of the Invention

The present invention relates to electrical connectors and more particularly high I/O (Input/Output) density connectors, such as a PGA (Pin Grid Array) socket connector.

2. Background of the invention

Electrical connectors are widely used in the art of computers to provide electrical connection between a chip package and an electrical substrate, such as a printed circuit board (PCB).

Typically, such a connector system comprises a pair of mating connectors including a male connector and a female connector. The male connector has a first insulative housing with a plurality of male contacts received therein. The female connector has a second insulative housing with a plurality of female contacts received therein. Each female contact includes a base portion, a pair of arm sections extending from the base portion, and a contacting end forming at a free end of the arm section. In use, the male contacts of the male connector are engaged with the corresponding contacting ends, such that the contacting ends are urged to deflect away from each other. At the same time, resilient deformation of the arm sections create mating force to ensure that the male contacts are tightly clamped between the contact ends, so as to provide electrical connection between male connectors and female connectors. Such typical connectors are disclosed in U.S. Pat. Nos. 6,042,389, 6,093,035, 6,146,983, 6,241,535, and 6,325,644.

The trend to reduce sizes of electronic equipments, particularly personal portable devices, with additional functions to such equipments, has resulted in an ongoing trend for miniaturization of all components, especially electrical connectors. The female contacts are fully received in the passageways of the typical connectors, so the contacting ends have less space for deflecting away from each other.

Therefore, there is a heretofore unaddressed need in the industry to address the aforementioned deficiencies and inadequacies.

### SUMMARY OF THE INVENTION

Accordingly, an object of a preferred embodiment of the present invention is to provide an electrical connector, for electrically connecting a chip package to an electrical substrate, having an increased space for contacts to deflect therein.

To fulfill the above-mentioned object, an electrical connector comprises a socket body and a plurality of contacts. The socket body defines a mating surface and a number of passageways. A plurality of contacts is received in the corresponding passageways. Each contact includes a base portion, a pair of arm sections extending from two opposite lateral sides of the base portion, and a contacting end forming at a free end of the arm section. The contacting ends extend upwardly and outwardly with a part extending out of the mating surface. Thus, there is a greater space for the contacting ends to deflect therein. Further more, a cover with a number of through-holes corresponding to the passageways is mounted on the socket body, which can be capable of effectively protecting the contacts from being damaged, especially during the transporting process.

Other objects, advantages and novel features of the present invention will become more apparent from the following detailed description when taken in conjunction with the accompanying drawings, in which:

### BRIEF DESCRIPTION OF THE DRAWINGS

FIG. 1 is an exploded, isometric view of an electrical connector in accordance with a preferred embodiment of the present invention, together with a contact out of a socket body;

FIG. 2 is an enlarged view of a circled portion A of FIG. 1;

FIG. 3 is a cross-section view taken along line B-B of FIG. 1, wherein pins of a chip package are engaged with contacting ends of the contacts, at an initial position;

FIG. 4 is an assembled view of FIG. 1; and

FIG. 5 is a cross-section view taken along line C-C of FIG. 4, wherein the pins of the chip package are engaged with contacting ends of the contacts, at a closed position.

### DETAILED DESCRIPTION OF THE PREFERRED EMBODIMENT OF THE INVENTION

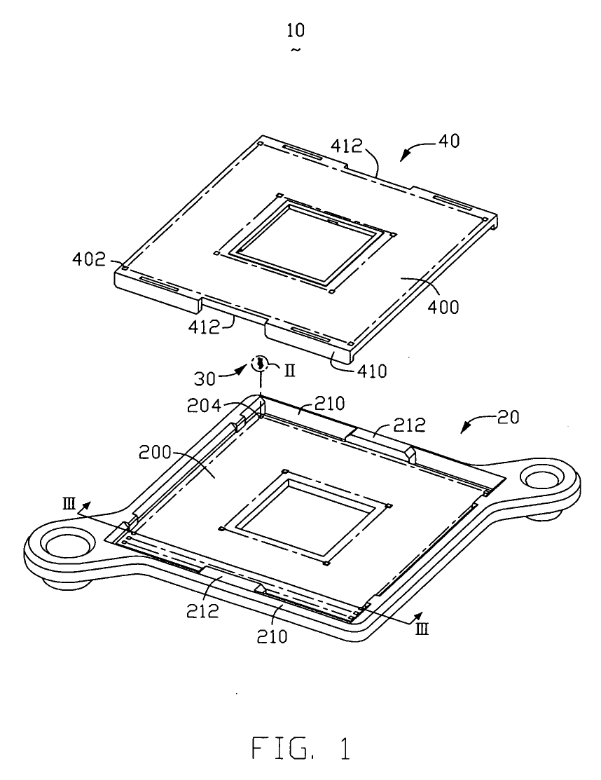

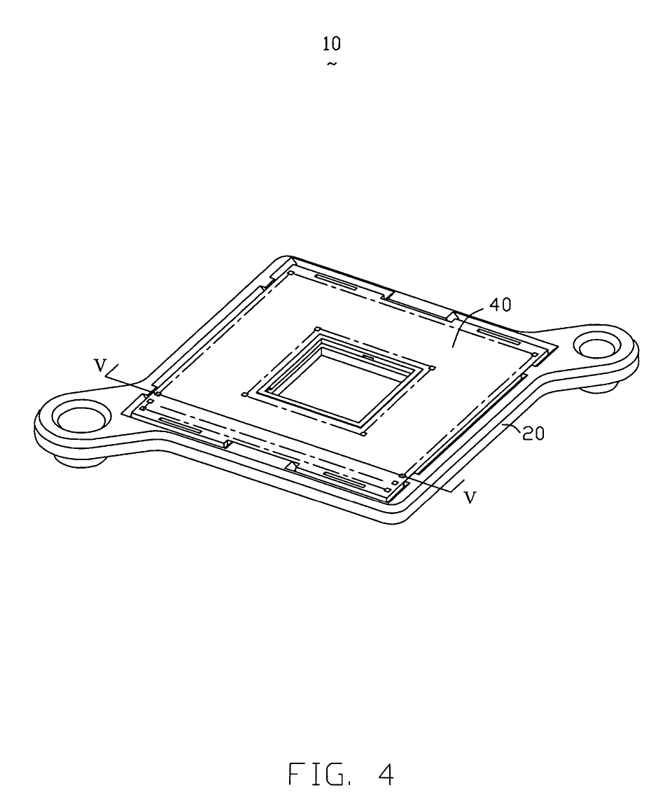

Referring to FIGS. 1-5, an electrical connector 10 in accordance with a preferred embodiment of the present invention includes a dielectric socket body 20, a plurality of contacts 30 received in the socket body 20 and a cover 40 mounted on the socket body 20.

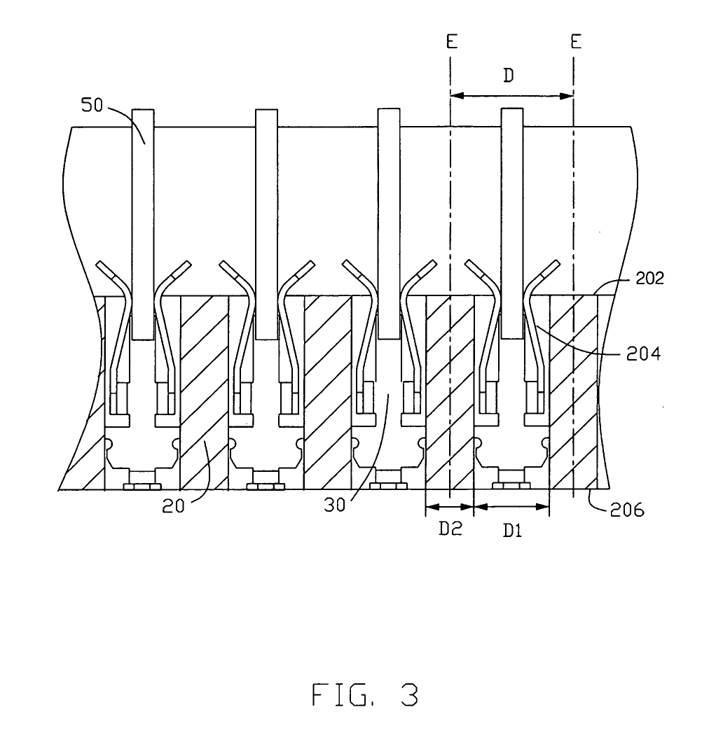

Referring to FIGS. 1 and 3, the dielectric socket body 20 comprises a body section 210 at an outer side thereof, and a bottom wall 200 recessed with respect to an upper surface of the body section 210 therebetween. The bottom wall 200 comprises a mating surface 202 and a mounting surface 206 opposite to the mating surface 202. The bottom wall 200 defines a plurality of passageways 204 extending vertically therethrough to receive corresponding contacts 30 therein. A pair of protrusions 212 is formed on two opposite lateral sides of body section 210 for clipping the corresponding locking sections 412 of the cover 40.

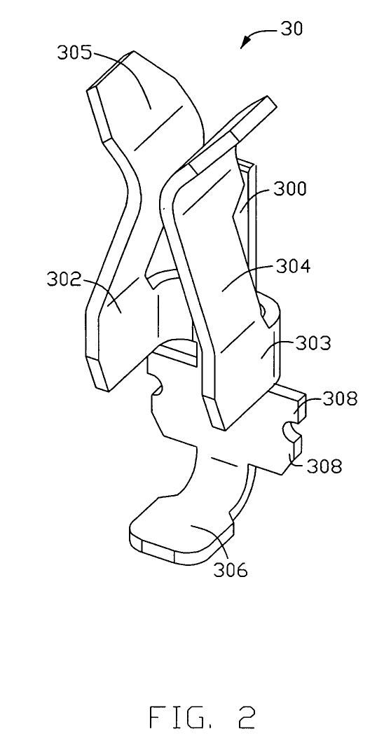

Referring to FIG. 2, each contact 30 is formed from conductive material and includes a base portion 300, a pair of arm sections 302 extending from two opposite lateral sides of the base portion 300, a pair of contacting ends 305 forming at two free ends of the arm sections 302, and a soldering section 306 extending perpendicularly from a bottom edge of the base portion 300.

A pair of flattened corners 308 is respectively formed at middle portions of two opposite lateral edges of the base portion 300. Each arm section 302 comprises a resilient arm 303 extending vertically from one lateral edge of the base portion 300, an extending arm 304, and a contacting end 305 projecting upwardly from at a free end of the extending arm 304. The contacting ends 305 extend upwardly and outwardly along the direction of the extending arms 304 for forming a smoothly curved surface.

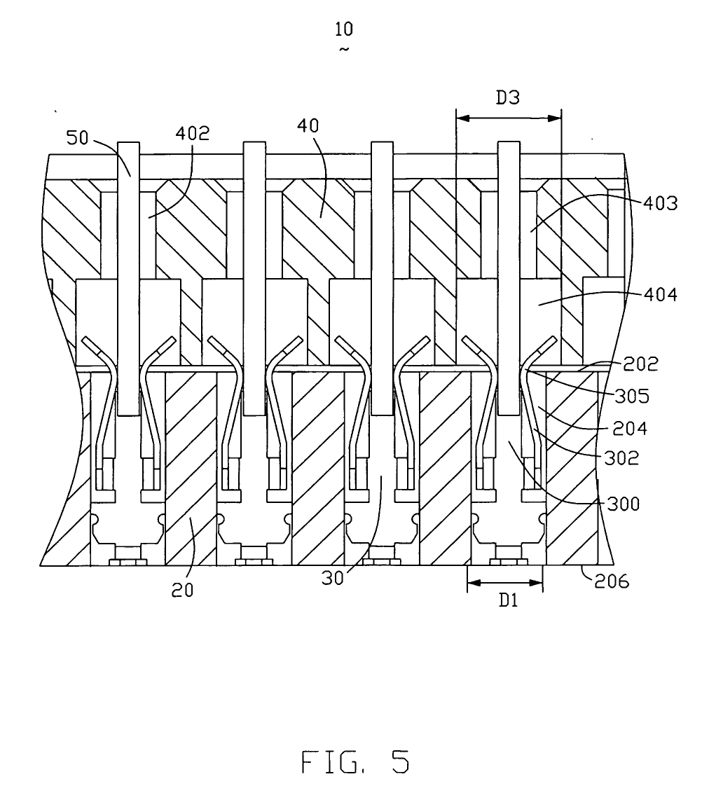

Referring to FIGS. 1 and 5, the cover 40 is an insulative planar board and defines an opening (not labeled) in a center thereof, a base 400, and a pair of walls 410 extending downwardly from the opposite lateral sides of the base 400. The base 400 defines a plurality of through-holes 402 extending vertically therethrough to correspond the passageways 204. Each through-hole defines a guiding groove 403 and a receiving passageway 404 communicating with the guiding groove 403. A distance between two opposite lateral sides of the receiving passageway is greater than a distance between two opposite lateral sides of the passageway. The walls 410 corresponding to the protrusions 212 of the body section 210 define a pair of locking sections 412.

Referring to FIGS. 3-5, during assembling, the contacts 30 are held within the corresponding passageways 204, and the opposite flattened corners 308 are engaged with insides of the passageways 204. Part of the contacting end 305 extends out of the mating surface 202. At last, the cover 40 is pressed down until the protrusions 212 engage with the corresponding locking sections 412.

Referring to FIG. 3, a first distance D1 is defined between two opposite sides of the passageway 204, and a second distance D2 is as a distance of a partition between two adjacent passageways 204. When the chip package is assembled onto the electrical connector 10, pins 50 of the chip package are engaged with the corresponding contacting ends 35 such that the contacting ends 35 are urged to deflect away from each other. At the same time, resilient deformation of the contacting ends 305 creates mating force to ensure that the pins are tightly clamped between the contact ends 305, so as to provide electrical connection between the pins 50 and the contacts 30. The effective space for the arm sections 20 to distort is increased from the first distance D1 to a sum of the first distance D1 and the second distance D2, i.e., the effective space is between two central lines E because of the part of the contacting section 305 of the contacts 30 extending out of the mating surface 202 of the socket body 20.

Referring to FIG. 5, when the pins 50 of the chip package are guided in the through-holes 402 of the cover 40 and engaged with the corresponding contacts 30, the first distance D1 is still defined between two opposite sides of the passageway, and a third distance D3 is defined between two opposite sides of the receiving passage 404. The real space for arm sections 20 to distort is limited by the third distance D3 because of the part of the contacting section 305 of the contacts 30 extending from the mating surface 202 of the socket body 20.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. An electrical connector comprising:
a socket body defining a mating surface and a number of passageways extending through the mating surface, and
a plurality of contacts received in the corresponding passageways, each contact including a base portion, a pair of arm sections extending from two opposite lateral sides of the base portion, and a contacting end forming at a free end of the arm section; wherein
the contacting end extends upwardly and outwardly beyond the mating surface of the socket body.

2. The electrical connector as claimed in claim 1, further including a cover mounted on the socket body, the cover defining a number of through-holes corresponding to the passageways of the socket body, each through-hole defining a guiding groove and a receiving passageway communicating with the guiding groove, a distance between two opposite lateral sides of the receiving passageway being greater than a distance between two opposite lateral sides of the passageway.

3. The electrical connector as claimed in claim 2, wherein the cover includes two locking sections formed on a pair of opposite lateral walls, respectively, and the socket body includes a pair of protrusions formed on a pair of opposite lateral sides for clipping the locking sections of the cover.

4. The electrical connector as claimed in claim 1, wherein the arm section comprises a resilient arm extending vertically from a lateral edge of the base portion, an extending arm extending angularly and upwardly away from the base portion, and the contacting end extending upwardly and outwardly along the direction of the extending arm.

5. The electrical connector as claimed in claim 4, wherein the contacting ends of the contact form a smoothly curved surface.

6. The electrical connector as claimed in claim 1, wherein a projection of the contacting end partially lies on the mating surface between two adjacent passageways.

7. An electrical connector comprising:
an insulative body defining a plurality of passageways therein;
a plurality of contacts disposed in the corresponding passageways, respectively, a contact portion of each of said contacts extending above an upper face of the body;
a cover seated upon the body and defining therein a plurality of passages in alignment with the corresponding passageways, respectively; wherein the passage includes an upper narrow section receiving a pin, and a lower wide section receiving both said pin and the corresponding contact portion which are engaged with each other.

8. The electrical connector as claimed in claim 7, wherein said pin extends downwardly from an electronic package.

9. The electrical connector as claimed in claim 8, wherein said contact portion extends beyond a boundary of the corresponding passageway from a top view of the body.
